(19) United States
(12) Patent Application Publication
(10) Pub. No.: US 2026/0301557 A1
(43) Pub. Date: Oct. 1, 2026

(54) ALARM APPARATUS AND ALARM METHOD

(71) Applicant: TOYOTA JIDOSHA KABUSHIKI KAISHA, Toyota-shi (JP)

(72) Inventor: Yuki NAKAGAWA, Toyota-shi (JP)

(73) Assignee: TOYOTA JIDOSHA KABUSHIKI KAISHA, Toyota-shi (JP)

(21) Appl. No.: 19/575,077

(22) Filed: Mar. 23, 2026

(30) Foreign Application Priority Data
Apr. 1, 2025 (JP) 2025-060791

(51) Int. Cl. G08B 21/22; B60Q 5/00; G07C 5/10

(52) U.S. Cl. CPC G08B 21/22; B60Q 5/005; G07C 5/10

(57) ABSTRACT

An alarm apparatus including a door sensor detects entering and exiting of a person to/from a vehicle based on information acquired by the door sensor, determines whether a specific person is left behind inside the vehicle based on the detection result when a driver has left the vehicle, and outputs an alarm when the specific person is left behind inside the vehicle. The information acquired by the door sensor includes whether a location in which a door opening/closing operation has been performed corresponds to a location related to the specific person, or whether a time period when the door opening/closing operation has been performed corresponds to a time period when the specific person frequently enters and exits the vehicle.

### CROSS-REFERENCE TO RELATED APPLICATION

This application claims priority to Japanese Patent Application No. 2025-060791, filed on Apr. 1, 2025, the entire contents of which are incorporated herein by reference.

### TECHNICAL FIELD

The present disclosure relates to an alarm apparatus and an alarm method.

### BACKGROUND

Technology for determining children left behind inside vehicles by monitoring the states of the interiors of the vehicles is known. For example, Patent Literature (PTL) 1 discloses determining a child left behind inside a vehicle based on an opening and closing operation history of a door of the vehicle and a millimeter-wave sensor, and issuing an alarm. PTL 2 discloses determining a child left behind inside a vehicle based on a door opening time, and issuing an alarm. PTL 3 discloses determining a child left behind inside a vehicle based on an elapsed time from when a door has been closed, and issuing an alarm. PTL 4 discloses acquiring location information on a vehicle when an occupant is exiting the vehicle, detecting a child left behind inside the vehicle according to the laws of the country or region of the acquired location information, and issuing an alarm.

### CITATION LIST

### Patent Literatures

PTL 1: JP 2022-182339 A

PTL 2: JP 2018-516418 A

PTL 3: JP 2016-149105 A

PTL 4: JP 2020-149488 A

### SUMMARY

However, specific individuals such as children, the elderly, and those who have difficulty in entering and exiting vehicles alone cannot smoothly enter and exit the vehicles, so it is required to perform entrance/exit determination for the specific individuals with higher accuracy.

It would be helpful to provide an alarm apparatus and alarm method capable of improving the accuracy of entrance/exit determination for a vehicle.

The gist of the present disclosure to solve the above problem is as follows.

(1) An alarm apparatus including:

a door sensor configured to output sensor information indicating the presence or absence of a door opening/closing operation of a vehicle, and whether a location in which the door opening/closing operation has been performed corresponds to a location related to a specific person or whether a time period when the door opening/closing operation has been performed corresponds to a time period when the specific person frequently enters and exits the vehicle; and

a controller configured to acquire the sensor information from the door sensor, and generate alarm information upon determining, based on the sensor information, that a driver has exited the vehicle and the specific person is left behind inside the vehicle.

(2) An alarm apparatus including a door sensor, the alarm apparatus configured to detect entering and exiting of a person to/from a vehicle based on information acquired by the door sensor, determine whether a specific person is left behind inside the vehicle based on the detection result when a driver has left the vehicle, and output an alarm when the specific person is left behind inside the vehicle,

wherein the information acquired by the door sensor includes whether a location in which a door opening/closing operation has been performed corresponds to a location related to the specific person, or whether a time period when the door opening/closing operation has been performed corresponds to a time period when the specific person frequently enters and exits the vehicle.

(3) The alarm apparatus according to (1) or (2), including a camera sensor configured to capture an image of inside or outside of the vehicle,

wherein the alarm apparatus is configured to determine whether the specific person is on board the vehicle, based on information acquired by the camera sensor.

(4) The alarm apparatus according to any one of (1) to (3), wherein the specific person includes a child, an elderly person, or a person who has difficulty in entering and exiting the vehicle alone.

(5) An alarm method including:

acquiring, by an alarm apparatus including a door sensor from the door sensor, sensor information indicating the presence or absence of a door opening/closing operation of a vehicle, and whether a location in which the door opening/closing operation has been performed corresponds to a location related to a specific person or whether a time period when the door opening/closing operation has been performed corresponds to a time period when the specific person frequently enters and exits the vehicle; and

generating alarm information upon determining, based on the sensor information, that a driver has exited the vehicle and the specific person is left behind inside the vehicle.

According to the present disclosure, the accuracy of entrance/exit determination for a vehicle can be improved.

### BRIEF DESCRIPTION OF THE DRAWINGS

In the accompanying drawings:

FIG. 1 is a diagram illustrating a schematic configuration of an alarm apparatus according to an embodiment of the present disclosure; and

FIG. 2 is a flowchart illustrating an example of operations of the alarm apparatus according to the embodiment of the present disclosure.

### DETAILED DESCRIPTION

An embodiment of the present disclosure will be described in detail below, with reference to the drawings.

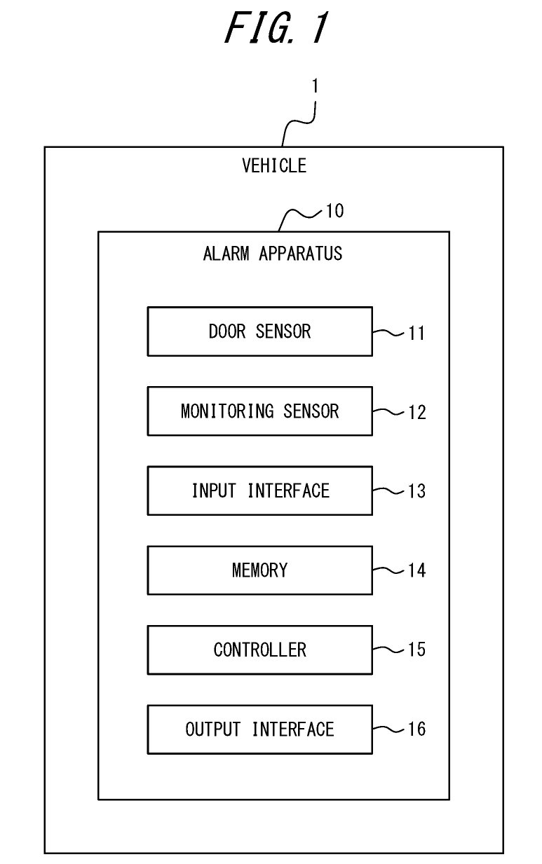

With reference to FIG. 1, a configuration of the alarm apparatus according to an embodiment will be described. As shown in FIG. 1, the alarm apparatus 10 mounted on the vehicle 1 includes a door sensor 11, a monitoring sensor 12, an input interface 13, a memory 14, a controller 15, and an output interface 16.

The door sensor 11 may be provided for each door of the vehicle 1 (for example, the right front door, left front door, right rear door, left rear door, and the hatchback door at the rear side of the vehicle 1). The door sensor 11 may be composed of multiple sensors. The door sensor 11 acquires sensor information. The sensor information includes information indicating the presence or absence of a door opening/closing operation. Additionally, the sensor information includes information indicating whether the location where the door opening/closing operation has been performed is related to a specific person, or whether the time period when the door opening/closing operation has been performed is a time period when the specific person frequently enters and exits the vehicle. Here, a "specific person" includes children, elderly persons, or persons who have difficulty in entering and exiting the vehicle alone (for example, persons with disabilities). A "location related to a specific person" includes, for example, a nursery, kindergarten, elementary school, nursing home, or hospital (for example, a pediatric clinic if the specific person is a child). A "time period when the specific person frequently enters and exits the vehicle" is, for example, a time period when the pick-up and drop-off of the child occurs frequently if the specific person is a child.

The monitoring sensor 12 includes a camera sensor that captures images of the inside and/or outside of the vehicle 1, a seat sensor that detects the presence or absence of seat belt usage, and a millimeter-wave sensor that detects occupants or objects inside the vehicle, and may be composed of multiple sensors. The controller 15 may determine whether the specific person is on board or whether the driver has left the vehicle based on the sensor information detected by the monitoring sensor 12, as will be described later.

The input interface 13 acquires sensor information from the door sensor 11 and the monitoring sensor 12 via an in-vehicle network such as CAN (Controller Area Network) or a dedicated line.

The input interface 13 may have an interface such as a physical key, capacitive key, or touch screen that accepts input from an operator. If the driver of the vehicle 1 inputs information indicating that a specific person is on board or is scheduled to board via the input interface 13, the alarm apparatus 10 may not need to be equipped with the monitoring sensor 12.

The memory 14 includes at least one semiconductor memory, at least one magnetic memory, at least one optical memory, or any combination thereof. The semiconductor memory is, for example, random access memory (RAM), read only memory (ROM), or flash memory. The memory 14 stores information detected by each sensor including the door sensor 11.

The controller 15 includes at least one processor, at least one programmable circuit, at least one dedicated circuit, or any combination thereof. The processor is a general purpose processor, such as a central processing unit (CPU) or a graphics processing unit (GPU), or a dedicated processor specialized for specific processing. The programmable circuit is, for example, a field-programmable gate array (FPGA). The dedicated circuit is, for example, an application specific integrated circuit (ASIC). The controller 15 executes processes related to the operations of the alarm apparatus 10 while controlling components of the alarm apparatus 10.

The controller 15 acquires sensor information from the door sensor 11 and the monitoring sensor 12 via the memory 14 and analyzes the sensor information. The controller 15 detects the boarding and alighting of a person to vehicle 1 based on sensor information, and determines whether a specific person is left behind inside vehicle 1 when the driver has left vehicle 1 based on the detection result of boarding and alighting. Then, when the controller 15 determines that a specific person is left behind, it generates alarm information to notify the driver of the abandonment. The controller 15 outputs the alarm information to output interface 16.

The controller 15 may determine whether a specific person is on board by analyzing images taken of the inside and/or outside of vehicle 1 based on sensor information from a camera sensor, which is a monitoring sensor 12. The controller 15 may determine that a child is on board when the seat belt of a child seat is being worn based on sensor information from a seat sensor, which is a monitoring sensor 12. The controller 15 may determine whether a specific person is on board based on sensor information from multiple types of sensors such as seat sensors, camera sensors, and millimeter-wave sensors. The controller 15 may determine whether a specific person is on board by analyzing sensor information using a pre-trained machine learning model.

The output interface 16 includes at least one interface for output. The interface for output is, for example, a display, a speaker, or the like. The output interface 16 outputs alarm information.

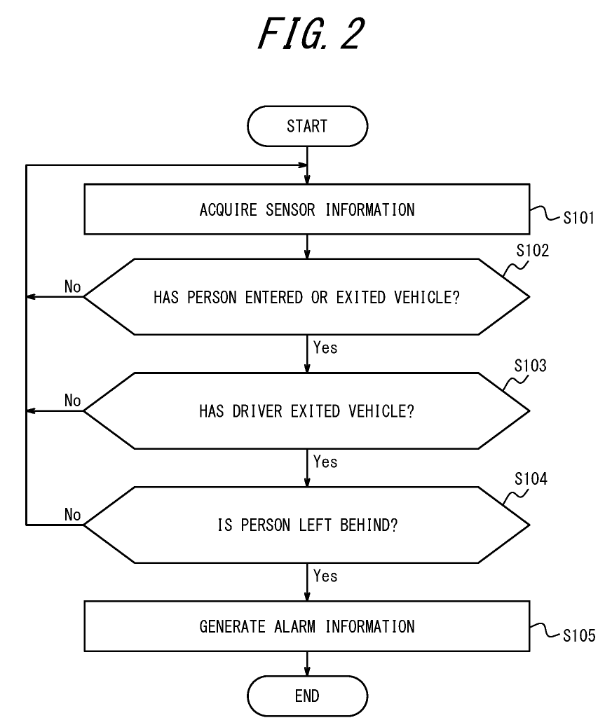

Next, referring to FIG. 2, an example of the operation of the controller 15 of the alarm apparatus 10 will be explained.

In S101, the controller 15 acquires sensor information from the door sensor 11. When the alarm apparatus 10 is equipped with a monitoring sensor 12, the controller 15 also acquires sensor information from the monitoring sensor 12.

In S102, the controller 15 determines the presence or absence of boarding and alighting of a person to vehicle 1 based on information indicating the presence or absence of door opening/closing operations. When the controller 15 detects the boarding and alighting of a person to vehicle 1 (i.e., when the determination result of S102 is Yes), it proceeds to process S103.

In S103, the controller 15 determines whether the driver has exited vehicle 1 and left vehicle 1 based on information indicating the presence or absence of door opening/closing operations of the driver's door. The controller 15 may determine whether the driver has exited vehicle 1 and left vehicle 1 based on information indicating the presence or absence of door opening/closing operations of the driver's door and sensor information from the camera sensor. When the controller 15 determines that the driver has left vehicle 1 (i.e., when the determination result of S103 is Yes), it proceeds to process S104.

In S104, the controller 15 determines whether the location where the door opening/closing operation was performed is a location related to a specific person, or whether the time period when the door opening/closing operation was performed is a time period when the specific person frequently enters and exits the vehicle, based on information indicating these conditions, to determine whether a specific person is left behind inside vehicle 1. When the controller 15 determines that a specific person is left behind inside vehicle 1 (i.e., when the determination result of S104 is Yes), it proceeds to process S105. For example, if the location where the door opening/closing operation has been performed is a nursery, or if the time period when the door opening/closing operation has been performed is during the time for dropping off and picking up at the nursery, the controller 15 will determine that a child is left in the vehicle based on sensor information from the camera sensor, even though the driver is away from the vehicle 1 in S103.

In S105, the controller 15 generates alarm information. If the determination result is No in either S102 to S104, the controller 15 returns the process to S101 and repeats the above processing.

As described above, the alarm apparatus 10 determines the presence or absence of a specific person being left behind based on sensor information that includes whether the location where the door opening/closing operation has been performed is related to a specific person, or whether the time period when the door opening/closing operation has been performed is a time period when the specific person frequently enters and exits the vehicle. Therefore, the alarm apparatus 10 can improve the accuracy of determining the entry and exit of a specific person.

### Program

It is also possible to use a computer capable of executing program instructions to function as the alarm apparatus 10 described above. The program can cause a computer to execute the operations described above, thereby enabling the computer to function as the alarm apparatus 10.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as a secure digital (SD) card, a digital versatile disc (DVD), or a compact disc read only memory (CD-ROM) on which the program is stored. The program may be distributed by storing the program in a storage of a server and transferring the program from the server to another computer. The program may be provided as a program product.

For example, the computer temporarily stores, in the memory 14, the program stored in the portable medium or the program transferred from the server. Then, the computer reads the program stored in the memory 14 using a processor and executes processing in accordance with the read program using the processor.

The computer may read the program directly from the portable medium, and execute processes in accordance with the program. The computer may, each time the program is transferred from the server to the computer, sequentially execute processes in accordance with the received program. Without transferring the program from the server to the computer, processes may be executed by a so-called application service provider (ASP) type service that realizes functions only by execution instructions and result acquisitions. The program encompasses information that is to be used for processing by an electronic computer and is thus equivalent to a program. For example, data that is not a direct command to a computer but has a property that regulates processing of the computer is "equivalent to a program" in this context.

The above-described embodiment has been explained as a representative example, but various modifications or changes can be made without departing from the spirit of the present disclosure. For example, it is possible to combine multiple configuration blocks or processing steps described in the embodiment into one, or to divide one into multiple blocks or steps.

1. An alarm apparatus comprising:
a door sensor configured to output sensor information indicating presence or absence of a door opening/closing operation of a vehicle, and whether a location in which the door opening/closing operation has been performed corresponds to a location related to a specific person or whether a time period when the door opening/closing operation has been performed corresponds to a time period when the specific person frequently enters and exits the vehicle; and
a controller configured to acquire the sensor information from the door sensor, and generate alarm information upon determining, based on the sensor information, that a driver has exited the vehicle and the specific person is left behind inside the vehicle.

2. An alarm apparatus comprising a door sensor, the alarm apparatus configured to detect entering and exiting of a person to/from a vehicle based on information acquired by the door sensor, determine whether a specific person is left behind inside the vehicle based on a detection result when a driver has left the vehicle, and output an alarm when the specific person is left behind inside the vehicle,
wherein the information acquired by the door sensor includes whether a location in which a door opening/closing operation has been performed corresponds to a location related to the specific person, or whether a time period when the door opening/closing operation has been performed corresponds to a time period when the specific person frequently enters and exits the vehicle.

3. The alarm apparatus according to claim 2, comprising a camera sensor configured to capture an image of inside or outside of the vehicle,
wherein the alarm apparatus is configured to determine whether the specific person is on board the vehicle, based on information acquired by the camera sensor.

4. The alarm apparatus according to claim 2, wherein the specific person includes a child, an elderly person, or a person who has difficulty in entering and exiting the vehicle alone.

5. An alarm method comprising:
acquiring, by an alarm apparatus including a door sensor from the door sensor, sensor information indicating presence or absence of a door opening/closing operation of a vehicle, and whether a location in which the door opening/closing operation has been performed corresponds to a location related to a specific person or whether a time period when the door opening/closing operation has been performed corresponds to a time period when the specific person frequently enters and exits the vehicle; and
generating alarm information upon determining, based on the sensor information, that a driver has exited the vehicle and the specific person is left behind inside the vehicle.
